(19) United States
(12) Patent Application Publication
(10) Pub. No.: US 2003/0051823 A1
(43) Pub. Date: Mar. 20, 2003

(54) Curtain-attached blind

(75) Inventor: Ming Nien, Changhua Hsien (TW)

Correspondence Address: BROWDY AND NEIMARK, P.L.L.C., 624 Ninth Street, N.W., Washington, DC, 20001-5303, US

(73) Assignee: Nien Made Enterprise Co., Ltd, Changhua Hsien (TW)

(21) Appl. No.: 09/953,303

(22) Filed: Sep. 17, 2001

(51) Int. Cl. E06B 3/32

(52) U.S. Cl. 160/89; 160/168.1 R

(57) ABSTRACT

A curtain-attached blind includes a blind, the blind having a plurality of slats, each slat having a front end, a rear end, and a connecting portion at the front end, a curtain, the curtain having a plurality of connecting members, and fasteners adapted to secure the connecting members of the curtain to the connecting portion of each of the slats.

### BACKGROUND OF THE INVENTION

The present invention relates to blinds and, more particularly, to a curtain-attached blind.

When the slats of a blind are closed to block the light, there are minor gaps in between the slats through which the light passes. In order to improve the light shading effect, the user may hang a curtain in front of the blind. The curtain also keeps the blind from sight. However, it is expensive to install an additional curtain, and the installation of the curtain requires much indoor installation space. Further, the positioning of the curtain in front of the blind hinders the operation of the blind. In order to eliminate these drawbacks, curtain-attached blinds are developed. However, these conventional curtain-attached blinds have the curtain fixedly fastened to the slats by an ultrasonic sealing apparatus. Because the curtain is not detachable, the cost is high, and the curtain cannot be removed from the blind for washing or replacement.

### SUMMARY OF THE INVENTION

The present invention has been accomplished to provide a curtain-attached blind, which eliminates the aforesaid problems. It is the main object of the present invention to provide a curtain-attached blind, which enables the user to detach the curtain from the blind for washing or replacement. To achieve this and other objects of the present invention, the curtain-attached blind is comprised of a blind, a curtain, and fasteners. The blind has a plurality of slats. Each slat has a front end, a rear end, and a connecting portion at the front end. The curtain has a plurality of connecting members. The fasteners can be snaps, adhesive means, hook and loop materials, or the like adapted to secure the connecting members of the curtain to the connecting portion of each of the slats.

### BRIEF DESCRIPTION OF THE DRAWINGS

FIG. 1 is a perspective view of a curtain-attached blind constructed according to a first embodiment of the present invention.

FIG. 2 is a sectional view of the curtain-attached blind of the first embodiment of the present invention.

FIG. 3 is a sectional view of a curtain-attached blind constructed according to a second embodiment of the present invention.

FIG. 4 is a sectional view of a curtain-attached blind constructed according to a third embodiment of the present invention.

FIG. 5 is a sectional view of a curtain-attached blind constructed according to a fourth embodiment of the present invention.

FIG. 6 is a sectional view of a curtain-attached blind constructed according to a fifth embodiment of the present invention.

FIG. 7 is a perspective view of a curtain-attached blind constructed according to a sixth embodiment of the present invention.

### DETAILED DESCRIPTION OF THE PREFERRED EMBODIMENT

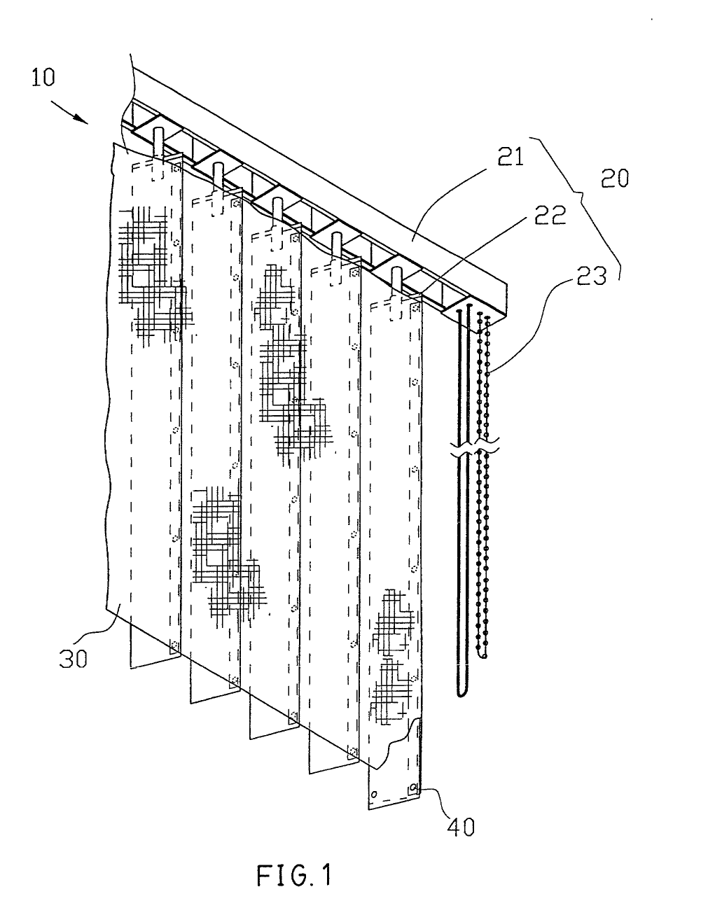

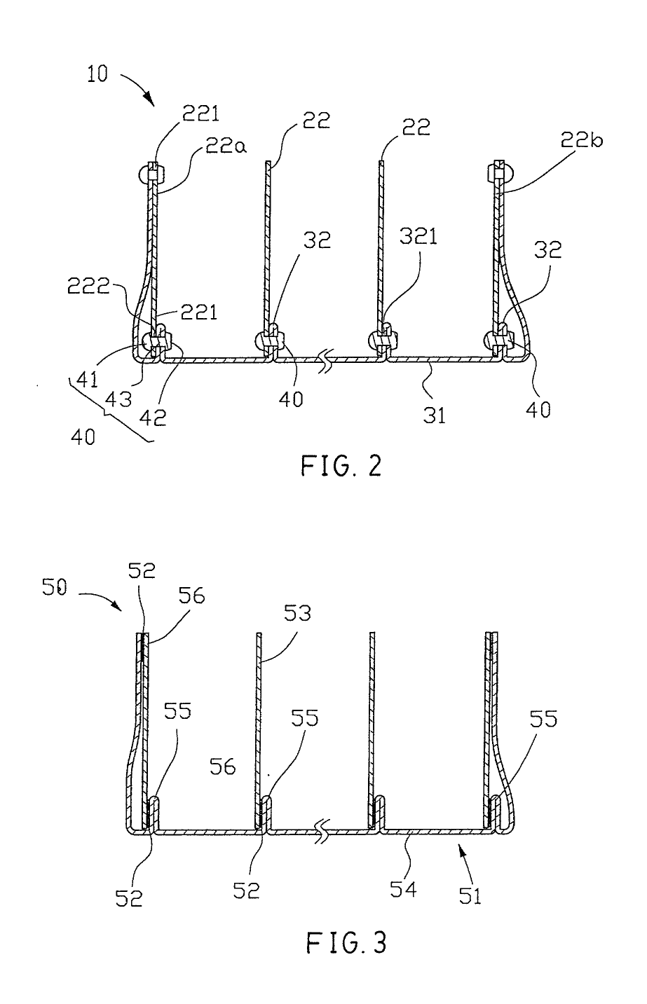

Referring to FIGS. 1 and 2, the curtain-attached blind 10 according to a first embodiment of the present invention is shown comprised of a blind 20, a curtain 30, and a plurality of fasteners 40.

The blind 20 comprises a head box 21, a plurality of slats 22, and an operating cord 23. The head box 21 is fixedly fastened to the wall above the window. The slats 22 are pivoted to the head box 21 and arranged in parallel at an equal pitch. Each slat 22 defines a front end and a rear end. An axially extended connecting portion 221 is respectively disposed at the front end of each slat 22 and the rear ends of the first slat 22a and the last slat 22b. The connecting portion 221 has an axially extended row of through holes 222 (the number of the through holes 222 can be 3, 5, or 7 subject to the length of the slats 22). The operating cord 23 is installed in the head box 21 and linked to the slats 22 for turning by hand to open/close the slats 23 so as to regulate the light.

The curtain 30 is a woven material of natural yarn (silk, wool, cotton) or synthetic yarn (nylon, Tetoron, etc.), comprising a curtain body 31 and a plurality of connecting members 32 at the curtain body 31. The curtain 30 is adapted to improve the light shading effect of the blind 20, and to decorate the blind 20. The covering area of the curtain body 31 is not less than the total covering area of the slats 22 when closed to block the light. The connecting members 32 are formed of a part of the curtain body 31, i.e., the curtain body 31 is curved and stitched to form the connecting members 32 at predetermined locations so that the connecting members 32 have a thickness twice the thickness of the curtain body 31. The connecting members 32 each have a plurality of through holes 321 corresponding to the through holes 222 of the connecting portions 221 of the slats 22.

The fasteners 40 are made of flexible material, for example, rubber, each comprising a first retaining portion 41 disposed at one end, a second retaining portion 42 disposed at the other end, and a base 43 connected between the first retaining portion 41 and the second retaining portion 42. The diameter of the base 43 is smaller than the diameter of the first retaining portion 41 and the diameter of the second retaining portion 42, and not greater than the through holes 222 of the connecting portions 221 of the slats 22 and the through holes 321 of the connecting members 32 of the curtain 30.

During installation, the first retaining portion 41 of each fastener 40 is respectively forced through the through holes 222 of the connecting portions 221 of the slats 22 and the through holes 321 of the connecting members 32 of the curtain 30. After installation, the first retaining portion 41 and second retaining portion 42 of each fastener 40 are respectively disposed at the outer side of the respective connecting portion 221 and the outer side of the respective connecting member 32 to secure the connecting members 32 of the curtain 30 to the connecting portions 221 of the slats 22 of the blind 20.

FIG. 3 shows a curtain-attached blind constructed according to a second embodiment of the present invention. According to this embodiment, the curtain-attached blind 50 comprises a blind (not shown), a curtain 51, and a plurality of fasteners 52.

The blind of the curtain-attached blind 50 comprises a head box (not shown), a plurality of slats 52, and an operating cord (not shown). The curtain 51 comprises a curtain body 54 and a plurality of connecting members 55 at the curtain body 54. The fasteners 52 are adhesive means, for example, double-sided adhesive tapes that adhere the connecting portions 56 of the slats 53 to the connecting members 55 of the curtain body 54 respectively.

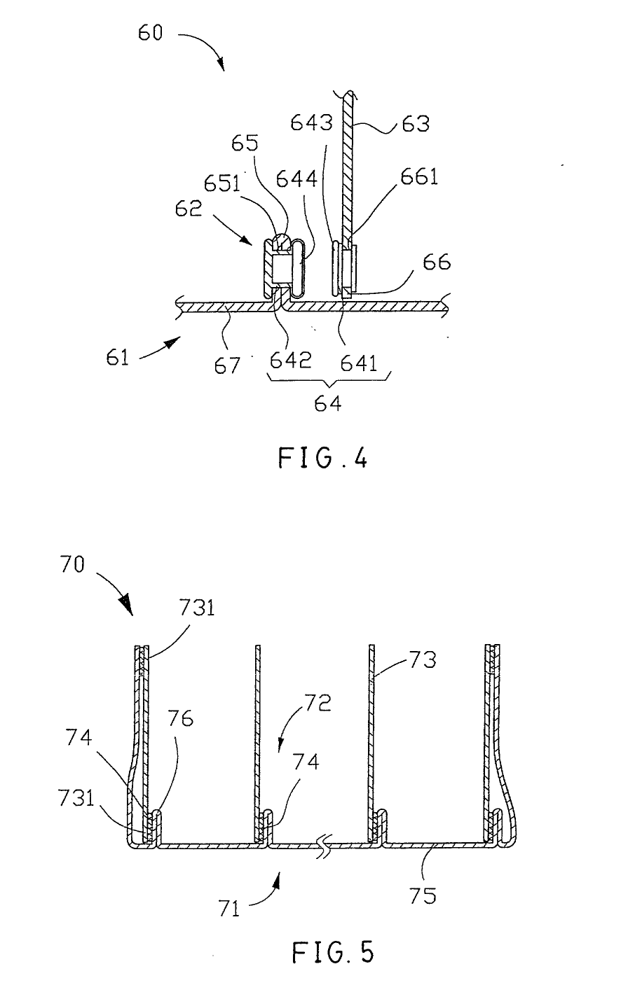

FIG. 4 shows a curtain-attached blind constructed according to a third embodiment of the present invention. According to this embodiment, the curtain-attached blind 60 comprises a blind (not shown), a curtain 61, and a plurality of fasteners 62.

The blind of the curtain-attached blind 60 comprises a head box (not shown), a plurality of slats 63, and an operating cord (not shown). The curtain 61 comprises a curtain body 67 and a plurality of connecting members 65 at the curtain body 67.

The fasteners 62 are snaps 64 each comprised of a stud element 641 and a socket element 642. The stud element 641 and socket element 642 of each of the snaps 64 are respectively installed in the through holes 661 of the connecting portions 66 of the slats 63 and the through holes 651 of the connecting members 65 of the curtain 61. By means of fastening the respective stud elements 641 to the respective socket elements 642, the slats 63 are secured to the connecting members 65 of the curtain 61. The stud element 641 has a post 643. The socket element 642 has a socket 644 adapted to receive the post 643. Forcing the post 643 of the stud element 41 of each of the snaps 64 into the socket 644 of the socket element 642 of each of the snaps 64 respectively, the snaps 64 are fastened up, and the curtain 61 is secured to the slats 63.

FIG. 5 shows a curtain-attached blind constructed according to a fourth embodiment of the present invention. According to this embodiment, the curtain-attached blind 70 comprises a blind (not shown), a curtain 71, and a plurality of fasteners 72.

The blind of the curtain-attached blind 70 comprises a head box (not shown), a plurality of slats 73, and an operating cord (not shown). The curtain 71 comprises a curtain body 75 and a plurality of connecting members 76 at the curtain body 75.

The fasteners 72 are Velcro tapes 74 respectively stitched to the connecting portions 731 of the slats 73, and the connecting members 76 of the curtain 71 are made of material that can be hooked up with the Velcro tapes 74. Therefore, the connecting members 76 of the curtain 71 can be detachably fastened to the connecting portions 731 of the slats 73.

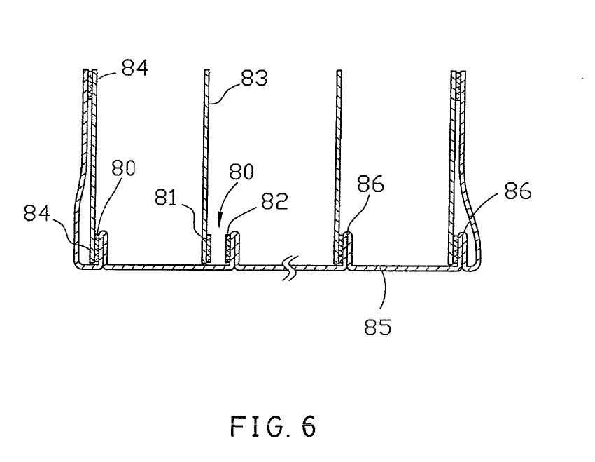

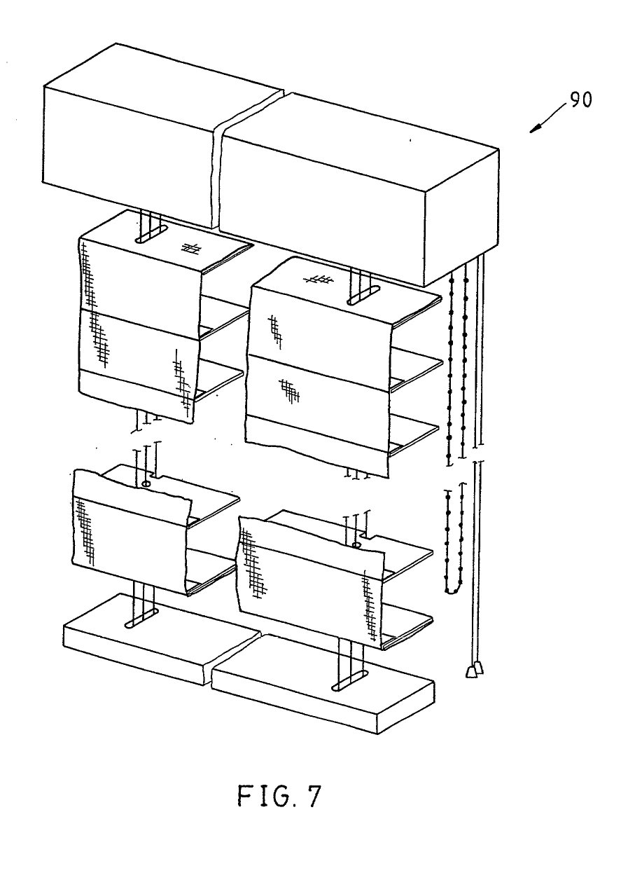

FIG. 6 shows a curtain-attached blind constructed according to a fifth embodiment of the present invention. Different from the aforesaid first to fourth embodiments, the fasteners 80 of the fifth embodiment are respectively comprised of a strip of hook material 81 and a strip of loop material 82 respectively stitched to the connecting portions 84 of the slats 83 and the connecting members 86 of the curtain 85, for enabling the connecting members 86 of the curtain 85 to be detachably fastened to the connecting portions 86 of the slats 85.

According to the aforesaid embodiments of the present invention, the slats of the blind are disposed in vertical. The invention can also be employed to regular Venetian blinds with horizontal slats. FIG. 7 shows the curtain coupled to the horizontal slats of a Venetian blind 90 according to the present invention.

As indicated above, the invention achieves the following advantages:

1. By means of the fasteners, the curtain can easily be fastened to the slats of the blind to improve the light shading effect of the blind and to decorate the blind.

2. The fasteners have a simple structure and are inexpensive to manufacture, and the consumers can install the curtain in the blind without any special training.

A prototype of curtain attached blind has been constructed with the features of FIGS. 1˜7. The curtain attached blind functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A curtain-attached blind comprising;
a blind, said blind comprising a plurality of slats, said slats each having a front end, a rear end, and a connecting portion at said front end;
a curtain, said curtain having a plurality of connecting members; and
fasteners adapted to secure said connecting members of said curtain to said the connecting portion of each of said slats.

2. The curtain-attached blind of claim 1 wherein said slats are arranged in parallel, the first slat and the last slat having a connecting portion respectively at the rear end thereof.

3. The curtain-attached blind of claim 1 wherein said curtain comprises a curtain body curved and stitched to form said connecting members at predetermined locations so that said connecting members have a thickness twice the thickness of said curtain body.

4. The curtain-attached blind of claim 1 wherein the connecting portions of said slats each have an axially extended series of through holes; the connecting members of said curtain each have an axially extended series of through holes corresponding to the through holes of the connecting portions of said slats; said fasteners are respectively fastened to the through holes of said connecting portions of said slats and the connecting members of said curtain, each comprising a base fitted into one through hole of one connecting portion of one of said slats and one through hole of one connecting member of said curtain, a first retaining portion disposed at one end of said base and stopped at one side of the corresponding connecting portion of the corresponding slat, and a second retaining portion disposed at an opposite end of said base and stopped at one side of the corresponding connecting member of said curtain.

5. The curtain-attached blind of claim 1 wherein said fasteners are adhesive means that adhere said connecting members of said curtain to said connecting portions of said slats.

6. The curtain-attached blind of claim 1 wherein said fasteners are snaps each comprised of a female fastening element installed in one connecting portion of one of said slats and a male fastening element installed in one connecting member of said curtain for connection to said female fastening element to secure the respective connecting member to the respective connecting portion.

7. The curtain-attached blind of claim 6 wherein said female fastening element is a socket element having a socket, and said male fastening element is a stud element having a post adapted to engage the socket of said socket element,

8. The curtain-attached blind of claim 1 wherein said fasteners are hook and loop materials respectively provided at the connecting portions of said slats and the connecting members of said curtain for enabling the connecting members of said curtain to be secured to the connecting portions of said slats.
